(19) United States
(12) Patent Application Publication
(10) Pub. No.: US 2015/0245307 A1
(43) Pub. Date: Aug. 27, 2015

(54) UL OUT-OF-SYNCHRONIZATION FOR A SECONDARY CELL CARRYING PUCCH

(71) Applicant: QUALCOMM Incorporated, San Diego, CA (US)

(72) Inventors: Wanshi Chen, San Diego, CA (US); Jelena Damnjanovic, Del Mar, CA (US); Peter Gaal, San Diego, CA (US)

(21) Appl. No.: 14/609,379

(22) Filed: Jan. 29, 2015

Related U.S. Application Data
(63) Continuation of application No. 61/943,243, filed on Feb. 21, 2014.

(51) Int. Cl. H04W 56/00; H04L 7/00

(52) U.S. Cl. CPC H04W 56/0005; H04L 7/0016

(57) ABSTRACT

Methods, systems, and devices are described for uplink synchronization for physical uplink control channel (PUCCH) enabled secondary cells (SCells). A UE may be able to determine that synchronization with a PUCCH-enabled SCell (“PUCCH-SCell”) is lost and to initiate synchronization. Additionally or alternatively, a base station may be configured to expediently determine that a UE has lost synchronization with a PUCCH SCell, and it may initiate synchronization. Either a UE or a base station, or both, may be configured to initiate synchronization depending on a particular carrier aggregation or dual-connectivity may be configured to determine that synchronization has been lost and initiate re-synchronization. In some embodiments, initiating a synchronization procedure may include a base station sending a PDCCH order on a PUCCH SCell, or a UE sending a random access preamble or an unsynchronization alert message on a PUCCH SCell.

### CROSS REFERENCES

The present application for patent claims priority to U.S. Provisional Patent Application No. 61/943,243 by Chen et al., entitled “UL Out-Of-Synchronization For A Secondary Cell Carrying PUCCH In LTE,” filed Feb. 21, 2014, assigned to the assignee hereof, and expressly incorporated by reference herein.

### BACKGROUND

1. Field of Disclosure

The following relates generally to wireless communication, and more specifically to uplink synchronization.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices. Base stations may communicate with mobile devices on downstream and upstream links. Each base station has a coverage range, which may be referred to as the coverage area of the cell. In some cases the coverage area may be subdivided into multiple cells. Also, in some cases, a base station may transmit multiple component carriers on different portions of available spectrum. These component carriers may also be referred to as cells.

A user equipment (UE) may be served by more than one carrier. In some cases a UE may be served by multiple carriers transmitted from a single base station (e.g., carrier aggregation); in other cases, a UE may be served by multiple carriers transmitted from more than one base station (e.g., dual-connectivity). In some instances, an “anchor” carrier is the main serving cell, or a primary cell (PCell), and is always active with respect to the UE communication session, while non-anchor carriers may be secondary cells (SCell) that can be configured/deconfigured and activated/deactivated depending on the UE data traffic. In some instances, only primary cell may carry a physical uplink control channel (PUCCH).

### SUMMARY

The described features generally relate to one or more improved systems, methods, and apparatuses for uplink synchronization for physical uplink control channel (PUCCH) enabled secondary cells (SCells). A UE may be able to determine that synchronization with a PUCCH-enabled SCell (“PUCCH SCell”) is lost and it may be able to initiate synchronization. Additionally or alternatively, a base station may be configured to expediently determine that a UE has lost synchronization with a PUCCH SCell, and it may initiate synchronization. Whether and how a UE or a base station is configured to initiate synchronization may depend on whether carrier aggregation or dual-connectivity is configured.

A method of communicating in a wireless communication network configured to support multiple component carriers is described. The method may include determining that a physical uplink control channel equipped secondary component carrier (PUCCH-SCC) is unsynchronized, and initiating a synchronization procedure.

A system for communicating in a wireless communication network configured to support multiple component carriers is described. The system may include means for determining that a physical uplink control channel equipped secondary component carrier (PUCCH-SCC) is unsynchronized, and means for initiating a synchronization procedure.

An apparatus for communicating in a wireless communication network configured to support multiple component carriers is described. The apparatus may include a processor, memory in electronic communication with the processor, and instructions stored on the memory, wherein the instructions are executable by the processor to determine that physical uplink control channel equipped secondary component carrier (PUCCH-SCC) is unsynchronized, and initiate a synchronization procedure.

A non-transitory computer-readable medium storing code for communicating in a wireless communication network configured to support multiple component carriers is described. The code may include instructions executable to determine that a PUCCH-SCC is unsynchronized, and initiate a synchronization procedure.

In some examples of the method, system, apparatus, or non-transitory computer-readable medium described above, the PUCCH-SCC includes a component carrier of a secondary timing adjustment group (sTAG), and initiating the synchronization procedure comprises transmitting an unsynchronization alert message.

Some examples of the method, system, apparatus, or non-transitory computer-readable medium described above may further include processes, features, means, or instructions for communicating with a first base station via a primary component carrier (PCC), and communicating with a second base station via the PUCCH-SCC, where the first and second base stations are connected via a non-ideal backhaul, and wherein the PUCCH-SCC is configured for dual-connectivity. In some examples, the transmitting is conditioned on a triggering event. In some examples, the unsynchronization alert message includes one of a medium access control signal or a radio resource control signal. In some examples, the transmitting comprises transmitting on a component carrier of a master cell group.

In some examples of the method, system, apparatus, or non-transitory computer-readable medium described above, the PUCCH-SCC includes a component carrier of a secondary timing adjustment group (sTAG), and initiating the synchronization procedure includes receiving an unsychronization alert message. In some examples, the unsynchronization alert message comprises one of a medium access control signal or a radio resource control signal. In some examples, receiving includes receiving the unsynchronization alert message from a base station of a master cell group via a backhaul link.

In some examples of the method, system, apparatus, or non-transitory computer-readable medium described above, initiating the synchronization procedure includes determining that a channel or signal or the PUCCH-SCC is undetected for a threshold period of time, electing, based on the determination that the channel or signal is undetected, to cease downlink or uplink scheduling for a secondary component carrier associated with the PUCCH-SCC, and transmitting, based on the determination that the channel or signal is undetected, an order on a physical downlink control channel of the PUCCH-SCC to perform a random access procedure. In some examples, the PUCCH-SCC and a primary component carrier (PCC) comprise component carriers of a common timing adjustment group. In some examples, the PUCCH-SCC includes a component carrier of a secondary timing adjustment group (sTAG) and a primary component carrier (PCC) comprises a component carrier of a primary timing adjustment group (pTAG).

In some examples of the method, system, apparatus, or non-transitory computer-readable medium described above, initiating the synchronization procedure includes transmitting a random access preamble on a physical random access channel of the PUCCH-SCC in an absence of receiving an order on a physical downlink control channel to perform random access procedures, and wherein the PUCCH-SCC is configured for carrier aggregation, and the PUCCH-SCC comprises a component carrier of a secondary timing adjustment group (sTAG). In some examples, determining the PUCCH-SCC is unsynchronized includes determining a timing adjustment (TA) timer for the sTAG expired, and initiating the synchronization procedure further comprises at least one of: flushing a hybrid automatic repeat request buffer for a component carrier, signaling for a release of PUCCH or a sounding reference signal for a component carrier, purging a configured downlink assignment or an uplink grant, or treating all TA timers as expired.

Some examples of the method, system, apparatus, or non-transitory computer-readable medium described above may further include processes, features, means, or instructions for communicating with a first base station via a primary component carrier (PCC), and communicating with the first base station via the PUCCH-SCC, where the PUCCH-SCC is configured for carrier aggregation. In some examples, the PUCCH-SCC is configured for carrier aggregation, the PUCCH-SCC includes a component carrier of a secondary timing adjustment group, and initiating the synchronization procedure comprises receiving a random access preamble on a physical random access channel of the PUCCH-SCC in an absence of transmitting an order on a physical downlink control channel to perform random access procedures.

Further scope of the applicability of the described methods, systems, apparatuses and computer program products will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an example of a wireless communication system in accordance with various embodiments;

FIG. 2 illustrates an example of a wireless communication system with multiple component carriers serving a wireless communication device in accordance with various embodiments;

FIG. 3 depicts a block diagram of a device(s) configured to determine unsynchronization or initiate a synchronization procedure in accordance with various embodiments;

FIG. 4 shows a diagram illustrating a non-contention based random access procedure according to various embodiments;

FIG. 5 depicts a block diagram a device(s) configured to determine unsynchronization or initiate a synchronization procedure in accordance with various embodiments;

FIG. 6 illustrates an example an offset between uplink and downlink frames of various frame structure types according to various embodiments;

FIG. 7 shows a diagram illustrating a contention-based random access procedure according to various embodiments;

FIG. 8 depicts a block diagram of a device(s) configured to determine unsynchronization or initiate a synchronization procedure in accordance with various embodiments;

FIG. 9 shows a diagram illustrating a synchronization procedure utilizing an unsynchronization alert message, in accordance with to various embodiments;

FIG. 10 shows an example of a wireless communications system with a UE served by carriers in a dual-connectivity arrangement in accordance with various embodiments;

FIG. 11 depicts a block diagram of a device(s) configured to determine unsynchronization or initiate a synchronization procedure in accordance with various embodiments;

FIG. 12 shows a block diagram of a UE configured to determine that a PUCCH SCell is unsynchronized or to initiate synchronization procedures in accordance with various embodiments;

FIG. 13 shows a block diagram of an example system configured to determine that a PUCCH SCell is unsynchronized or to initiate synchronization procedures in accordance with various embodiments;

FIG. 14 shows a flowchart illustrating a method of wireless communication in accordance with various embodiments;

FIG. 15 shows a flowchart illustrating a method of wireless communication in accordance with various embodiments; and

FIG. 16 shows a flowchart illustrating a method of wireless communication in accordance with various embodiments.

### DETAILED DESCRIPTION

In some implementations, SCells may carry a PUCCH in both carrier aggregation and dual-connectivity scenarios. These SCells may be called PUCCH-enabled SCells, PUCCH-equipped SCells (“PUCCH-SCell”), or PUCCH-equipped secondary component carriers (“PUCCH-SCC”). It is possible for a UE to lose synchronization—e.g., uplink synchronization—with a serving cell. Depending on whether the unsynchronized cell is a PCell or an SCell, a UE may not be able to initiate procedures to re-establish synchronization. Meanwhile, a base station may continue to operate, temporarily oblivious to the lost synchronization. It may therefore be beneficial to configure a UE or a base station, or both to determine that uplink synchronization to a PUCCH-enabled SCell has been lost, and either or both devices may initiate a synchronization procedure.

Whether a UE or a base station initiates synchronization may be a function of a system configuration. For example, if a UE is served by multiple component carriers from a single base station, certain synchronization procedures may be more expedient if initiated by the base station. But for a UE in some carrier aggregation and dual-connectivity configurations, synchronization may be more readily initiated by the UE.

In some cases, such as a single base-station carrier aggregation scenario, a base station may initiate synchronization procedures if the base station is not able to detect one or more configured, or scheduled, channels or signals of a PUCCH SCell. For instance, if the base station is unable to detect one or more configured or scheduled physical uplink shared channel (PUSCH), physical uplink control channel (PUCCH), or sound reference signals (SRS) within a certain period of time or during a certain number of consecutive time instances, the base station may cease either or both downlink and uplink scheduling for SCells associated with the PUCCH SCell. The base station may then transmit a physical downlink control channel (PDCCH) order for the UE to perform a random access procedure.

In some embodiments, it may be possible to facilitate synchronization on a PUCCH SCell by placing certain restrictions on a system. For example, a PUCCH SCell may be restricted to those timing adjustment groups (TAG) having a primary cell (PCell). In such cases, the PUCCH SCell may thus have the same uplink timing as the PCell. This type of restriction may be beneficial in a single-serving-base station, carrier aggregation scenario.

Additionally or alternatively, a UE may be able to initiate a random access procedure on a PUCCH SCell. For instance, a UE may initiate random access on PUCCH SCell of a secondary TAG (sTAG) in a manner similar to a contention-based random access process on a PCell.

In still further embodiments, a UE may be configured to inform or notify a base station that synchronization of a PUCCH SCell has been lost. For instance, a UE may transmit an unsynchronization alert message or signal that uplink synchronization has been lost on a PUCCH SCell of an sTAG. In some cases, the message may be triggered by a particular status or event—e.g., an uplink or downlink grant, or a configured SRS or channel state information (CSI) event. The manner in which the message is transmitted may be a function of the configuration of cells serving a UE—in a dual-connectivity configuration, the message may be transmitted on cell of a master base station, while in a single-serving-base station carrier aggregation configuration, the message may be sent on any cell.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

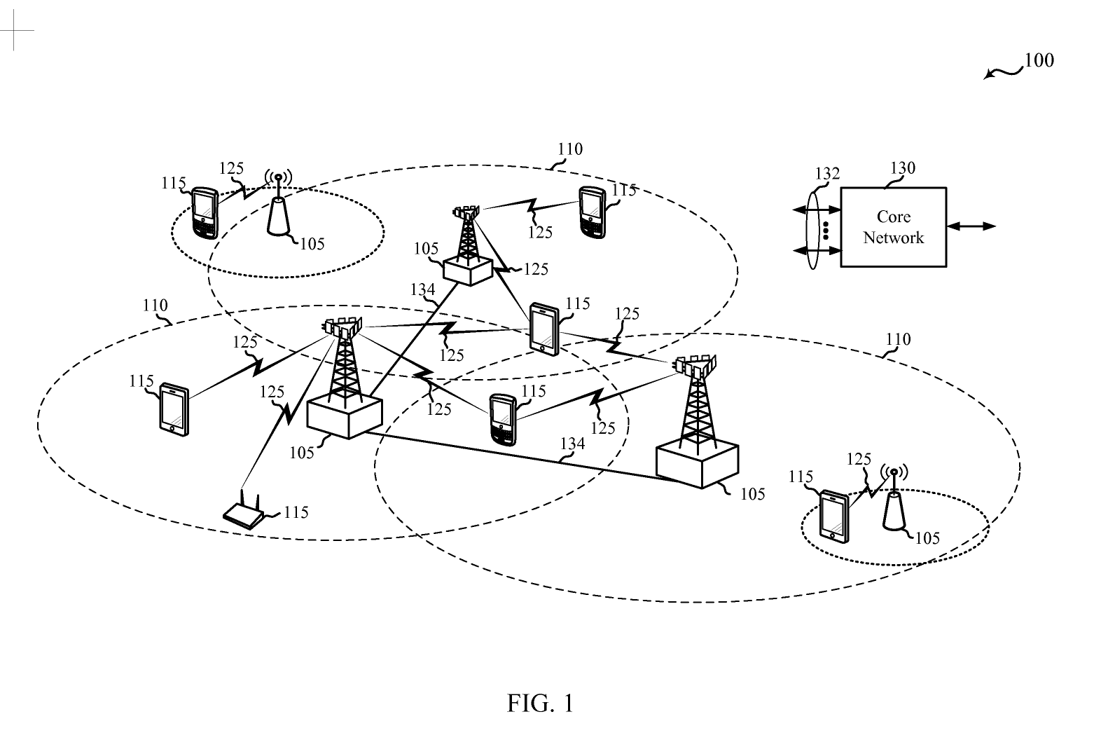

Referring first to FIG. 1, an example of a wireless communication system 100 is illustrated in accordance with various embodiments. The system 100 includes base stations 105, communication devices, also known as user equipment (UE) 115, and a core network 130. The base stations 105 may communicate with the communication devices 115 under the control of a base station controller (not shown), which may be part of the core network 130 or the base stations 105 in various embodiments. Base stations 105 may communicate control information or user data with the core network 130 through backhaul links 132. In some embodiments, the base stations 105 may communicate, either directly or indirectly, with each other over backhaul links 134, which may be wired or wireless communication links.

The system 100 may support operation on multiple carriers (e.g., waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, and the like. A particular combination of carriers may dictate a manner in which a UE 115 synchronizes with various carriers of a base station 105. As described below, a UE 115 may be served from various base stations 105, some of which may be configured with multiple carriers. The carriers may be associated with one another, for example as members of a common TAG; and this association may be utilized to determine a loss of synchronization or to initiate synchronization.

The base stations 105 may wirelessly communicate with the devices 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, an eNodeB (eNB), a Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, or pico base stations). There may be overlapping coverage areas for different technologies.

In some embodiments, the system 100 is an LTE/LTE-A network. In LTE/LTE-A networks, the terms evolved Node B (eNB) and UE may be generally used to describe the base stations 105 and devices 115, respectively. The system 100 may be a Heterogeneous LTE/LTE-A network in which different types of eNBs 105 provide coverage for various geographical regions. For example, each eNB 105 may provide communication coverage for a macro cell, a small cell, or other types of cell. The term “cell” is a 3GPP term that can be used to describe a base station, a carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station that may operate in the same or different (e.g., licensed, unlicensed, etc.) frequency bands as macro cells. Small cells include pico cells, femto cells, and micro cells. A pico cell would generally cover a relatively smaller geographic area and may allow unrestricted access by UEs with service subscriptions with the network provider. A femto cell would also generally cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

An eNB 105 may include a base band unit (BBU) and one or more remote radio heads (RRHs), which may be connected by an electrical or optical internal interface (e.g., common public radio interface (CPRI), etc.) to the BBU. Thus RRHs typically have an ideal backhaul to the BBU and operate under the control (e.g., scheduling, precoding, etc.) of the eNB 105. The term small cell network may be used to refer to distributed radio technology including a centralized BBU and one or more RRHs. But each RRH of a small cell network typically uses the same carrier frequencies and transmits on resources scheduled by the BBU. Therefore, all of the RRHs of such a distributed radio network connected to the same BBU are part of one base station or eNB for the purposes of this description. In a dual-connectivity configuration, a UE may be served from different BBUs each having RRHs. In such a dual-connectivity configuration, a UE may utilize on BBU to communicate an unsynchronization alert to another BBU, even if the backhaul between BBUs may be non-ideal.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) or via backhaul links 132 (e.g., through core network 130). The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The backhaul links 132, 134 may be exploited by eNBs 105 to support synchronous and asynchronous operation. For example, eNBs 105 may communicate messages related to unsynchronization to one another via backhaul links 134.

The communication networks that may accommodate some of the various disclosed embodiments may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between the UE and the network used for the user plane data. At the Physical (PHY) layer, the transport channels may be mapped to Physical channels.

The UEs 115 are dispersed throughout the wireless communications system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a smartphone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in system 100 may include uplink (UL) transmissions from a UE 115 to a base station 105, or downlink (DL) transmissions, from a base station 105 to a UE 115. The downlink transmissions may also be called forward link transmissions, and the uplink transmissions may also be called reverse link transmissions. The links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. As discussed in more detail below, in a TDD operation, an UL frame may include an offset (e.g., 20 μs), which allows a device (e.g., an eNB) to switch from a receiving to a transmitting mode.

Wireless network 100 may support operation on multiple carriers, which may be referred to as carrier aggregation (CA) or multi-carrier operation. A carrier may also be referred to as a component carrier (CC), a layer, a channel, etc. The terms “carrier,” “CC,” and “cell” may be used interchangeably herein. A carrier used for the downlink may be referred to as a downlink CC, and a carrier used for the uplink may be referred to as an uplink CC. A UE 115 may be configured with multiple downlink CCs and one or more uplink CCs for carrier aggregation. Carrier aggregation may be used with various combinations of FDD and TDD component carriers. In FDD/TDD carrier aggregation, carrier configuration may need to account for TDD UL timing offsets. For example, the TDD carrier(s) may be configured without a fixed offset. Or, in other examples, the FDD carrier(s) may be configured with an offset corresponding to the TDD carrier(s) (e.g., an FDD UL carrier may be configured with a 20 μs).

In some embodiment, the various UEs 115 are each configured with a UE-specific primary component carriers (PCC) (also referred to as a “primary cell” or “PCell”) or one or more secondary component carriers (also referred to as a “secondary cells” or “SCells”). The PCell may include a downlink PCC and an uplink PCC. An SCell may include a downlink SCC and, if configured, an uplink SCC. Control information including scheduling for SCells may be performed on the SCell or on a different cell (PCell or SCell), which may be referred to as cross-carrier control signaling. The PCell may be identified by the UE 115 prior to establishing a connection with an eNB 105 (e.g., as the strongest available carrier). Once the UE 115 establishes a connection with an eNB 105 via the PCell, one or more SCells may be configured via higher layer signaling (e.g., RRC, etc.). Configuration of SCells may include, for example, sending all system information (SI) for the SCell over RRC signaling. Groups of cells configured to be scheduled from another cell may be referred to as associated cells or associated CCs.

In some cases, both PCell and SCells are supported by the same base station 105. In other cases, the PCell may be supported by one base station 105 and one or more SCells may be supported by the same base station 105 or a different base station 105. The techniques described herein may be applied to a carrier aggregation scheme with a PCell and any number of SCells supported by one or more base stations 105. As alluded to above, a configuration in which a UE 115 is served from different base stations 105 may be referred to as a dual-connectivity configuration. In dual-connectivity, one or more of the serving base stations 105 may support carrier aggregation.

In some cases, configured SCells are activated and deactivated for individual UEs 115 by a configuring cell using a primary carrier (e.g., PCell, etc.). For example, activation and deactivation commands for configured SCells may be carried in MAC signaling. When an SCell is deactivated, the UE 115 does not need to monitor for control information for the SCell, does not need to receive the corresponding downlink CC, cannot transmit in the corresponding uplink CC, nor is it required to perform channel quality information (CQI) measurements. Upon deactivation of an SCell, the UE may also flush all HARQ buffers associated with the SCell. Conversely, when an SCell is active, the UE 115 receives control information or data transmissions for the SCell, and is expected to be able to perform CQI measurements. The activation/deactivation mechanism is based on the combination of a MAC control element and deactivation timers. The MAC control element carries a bitmap for the individual activation and deactivation of SCells such that SCells can be activated and deactivated individually, and a single activation/deactivation command can activate/deactivate a subset of the SCells. One deactivation timer is maintained per SCell but one common value is configured per UE by RRC.

In earlier versions of LTE, the PCell was characterized by a number of functional differences from an SCell. For example, the PCell was the only PUCCH-enabled cell and thus the cell upon which a UE 115 would perform an initial connection establishment. In such cases, uplink control information (e.g., ACK/NAK, CQI, and SR) was transmitted on the PCell. For instance, in LTE-A Release 10, a configuration of five DL CCs to one UL CC is possible, and the one UL CC must support HARQ transmission on PUCCH for the up to five DL CCs. Furthermore, in past implementations, a PDCCH order to initiate random access procedures could only be received on the PCell; and PRACH preambles could only be sent on the PCell.

As described herein, certain SCells may be enabled with some functionality similar to a PCell. For example, a PUCCH-enabled SCell may be established. This PUCCH-enabled SCell may be variously referred to as a PUCCH SCell, a PUCCH-enabled SCC, a PUCCH-SCC, a Special SCell with PUCCH, a Special SCell, a Special SCC, an SPCell, and the like. PUCCH SCells may be configured for FDD carrier aggregation, TDD carrier aggregation, and TDD/FDD carrier aggregation. PUCCH SCells may reduce PUCCH overhead on PCells, which may be significant for PCells (e.g., macro cells) associated with a large number of small cells (e.g., pico cells).

In some cases, the PUCCH SCell may transmit PDCCH orders to initiate random access procedures, or it may receive PRACH preambles from a UE 115. Additionally or alternatively, the PUCCH SCell may be configured to receive or recognize unsynchronization alert messages from a UE 115 or an eNB 105. Accordingly, when synchronization is lost on an UL PUCCH SCell, various manners of determining the lost synchronization, and initiating synchronization may be employed, some without the necessity of an PCell.

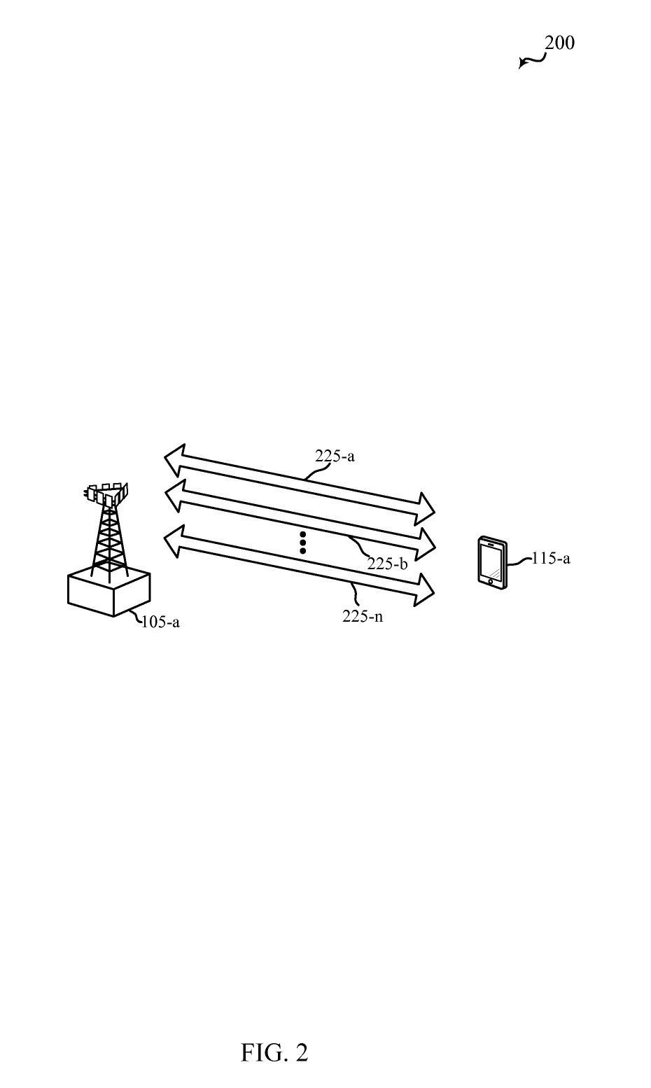

FIG. 2 illustrates an example of a wireless communications system 200 with a UE 115-a served by carriers 225 in accordance with various embodiments. The system 200 may be an example of various aspects of the system 100 of FIG. 1. In one embodiment, carrier 225-a may be a primary component carrier (e.g., PCell or PCC) and other carriers (e.g., 225-b, 225-n, etc.) may be one or more secondary component carriers (e.g., SCells or SCC). The PCell may include a downlink primary CC and an uplink primary CC. An SCell may include a downlink secondary CC and, if configured, a uplink secondary CC. In some cases, both PCell 225-a and SCells 225-b, 225-n are supported by the same base station 105-a. Additionally or alternatively, one of the SCells 225-b, 225-n may be a PUCCH-SCC. The techniques described herein may be applied to a carrier aggregation scheme with a PCell and any number of SCells supported by one or more than one base station 105.

In some cases, PCell 225-a may be supported by one base station 105-a and one or more SCells 225 may be supported by a different base station 105 (not shown). As discussed in more detail below, a carrier group that includes a PCell may be referred to as a master cell group (MCG), while a carrier group that includes a PUCCH SCell, and not a PCell, may be referred to as a secondary cell group (SCG). Thus, in some embodiments, the system 200 is an SCG. In such cases, the PUCCH of the PUCCH SCell provides HARQ feedback for all carriers of the SCG.

The eNB 105-a may make timing adjustment (e.g., timing advance) measurements and transmit timing advance instructions to the UE 115-a. Timing adjustment may be used to control UE 115 transmit timing. For example, the eNB 105-a may make a timing advance measurement and use the timing advance measurement to identify a distance to a UE 115-a. The eNB 105-a, or various CCs of the eNB 105-a, may transmit timing advance instructions, based on the timing advance measurement, to control UE 115-a transmit time. Such timing advance instructions may account for delays (e.g., propagation delay) resulting from the physical distance between the eNB 105-a and the UE 115-a.

The system 200 may also support different timing adjustment for different groups of carriers serving a common UE 115. Multiple timing adjustment groups (TAGs) may be beneficial when, for instance, different frequency bands (e.g., different component carriers) require different timing advance (e.g., when repeaters are employed in one band, or to account for different internal delays of band-specific repeaters). A TAG may be defined as a group of serving cells configured by RRC that, for those cells having an uplink CC configured, use a common timing reference cell and a common timing advance value. In some cases, a primary TAG (pTAG) may be defined as a TAG that contains a PCell; and one or more secondary TAGs (sTAGs) may be defined as TAGs that do not contain the PCell.

Those skilled in the art will note that, for an sTAG without a PUCCH SCell, random access by a UE 115 is limited to non-contention based random access procedures. Thus, in implementations, if synchronization is lost, re-synchronization may require an eNB 105 to send a PDCCH order. In such cases, the eNB 105 may not be immediately aware that the UE is UL unsynchronized on SCells of the sTAG, and the eNB 105 may not expediently send a PDCCH order to initiate synchronization. Those skilled in the art will also recognize if an sTAG includes a PUCCH SCell, and if an eNB 105 has to blindly detect whether the PUCCH SCell is out-of-synch or not, UL and DL traffic of all cells of the sTAG may be jeopardized because blind detection may be time intensive. Thus, the system 200 may be configured such that either or both the eNB 105-a or the UE 115-a may determine that a PUCCH SCell is unsynchronized and, in various embodiments, either may initiate a synchronization procedure.

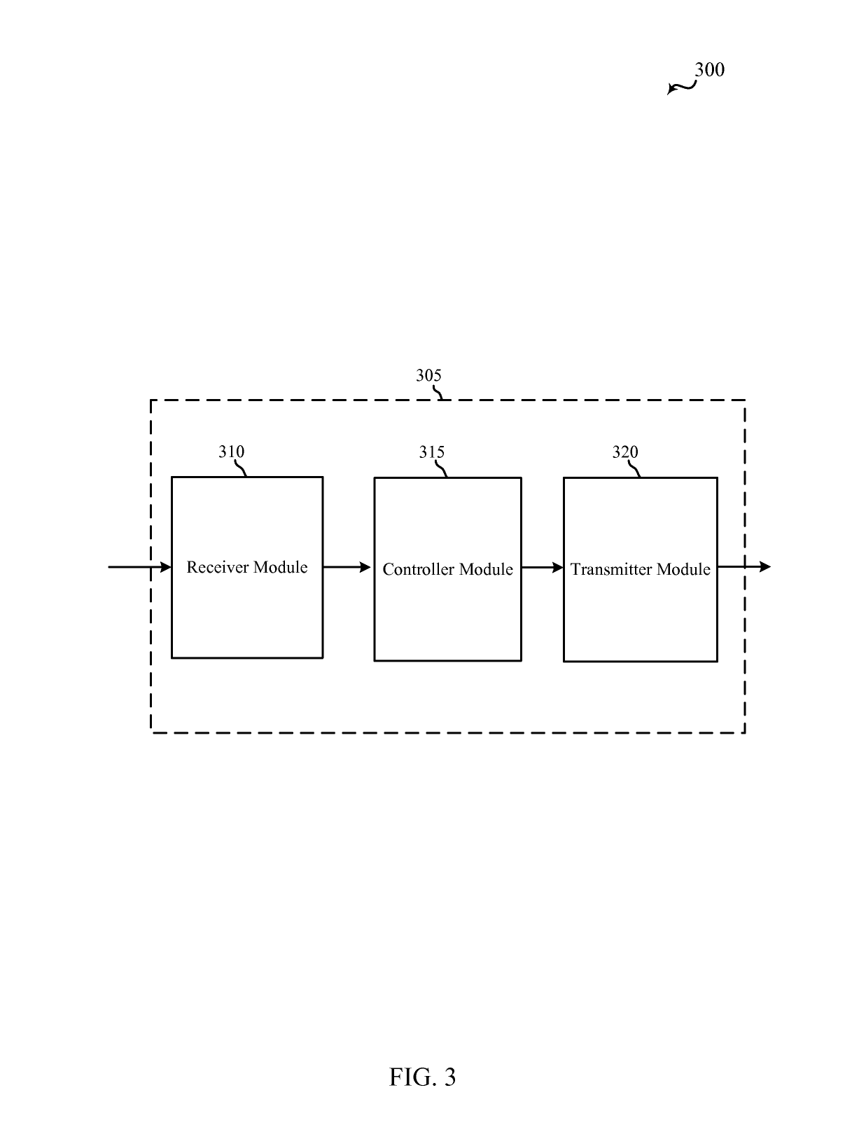

FIG. 3 depicts a block diagram 300 of a device(s) 305 configured to determine unsynchronization or initiate a synchronization procedure in accordance with various embodiments. In various embodiments, the device 305 is an example of various aspects of the eNBs 105 and UEs 115 described herein. The device 305 may include a receiver module 310, a controller module 315, and a transmitter module 320, which may each be in communication with one another. The various modules of the device 305 may be means for performing the functions described herein. In some embodiments, one or more aspects of the device 305 is a processor.

The controller module 315 may be configured to determine that a PUCCH SCell (e.g., a PUCCH-SCC) is unsynchronized. In some embodiments, the receiver module 310 is configured to initiate a synchronization procedure. In other examples, the transmitter module 320 is configured to initiate a synchronization procedure. Whether the receiver module 310 or the transmitter module 320 initiates the synchronization procedure may depend on whether the device 305 is an aspect of an eNB 105 or a UE 115.

The components of the device 305 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

Referring again to system 200 of FIG. 2, in some embodiments, the UE 115-a includes a configurable timer (e.g., timeAlignmentTimer) for each TAG. These timers may be used to control how long the UE 115-a considers the serving cells (e.g., CCs) of each TAG to be uplink-time aligned—e.g., uplink synchronized. If the UE 115-a fails to receive a timing advance instruction for a TAG, the timeAlignmentTimer for that TAG may expire, which may cause the UE 115-a to initiate certain synchronization procedures. For example, if a timer associated with a pTAG, or for an sTAG with a PUCCH SCell expires, the UE 115-a may undertake a number of actions to initiate synchronization. The UE 115-a may: flush all HARQ buffers for all serving cells; notify higher layers (e.g., RRC) to release PUCCH or SRS for all serving cells; clear any configured DL assignments or UL grants; and deem all running timeAlignmentTimers to be expired. If, however, a timer associated with an sTAG that does not include a PUCCH SCell expires, the UE 115-a may undertake more limited action—e.g., flushing all HARQ buffers and notifying higher layers (e.g., RRC) to release SRS—but the UE 115-a may remain unsynchronized until the eNB 105-a sends a PDCCH order to perform random access procedures.

In some embodiments, the eNB 105-a may initiate a synchronization procedure. The eNB 105-a may determine that a channel or signal of the PUCCH SCell (e.g., PUCCH-SCC) is undetected for a threshold period of time. The channel or signal may be a configured or scheduled channel or signal. For example, the channel/signal could be PUSCH, PUCCH, or an SRS. The threshold period of time may, in some cases, be a number of consecutive instances in which a channel or signal is undetected. The eNB 105-a may thus elect to cease DL or UL scheduling for an SCell (e.g., an SCC) associated with the PUCCH SCell. In some cases, the eNB 105-a elects to cease scheduling on the PUCCH SCell or on other SCells configured by higher layers to be scheduled by the PUCCH SCell. In other cases, the eNB 105-a elects to cease scheduling on all SCells. The eNB 105-a may then initiate a non-contention-based random access procedures—e.g., by transmitting a PDCCH order to the UE 115-a to perform random access procedures.

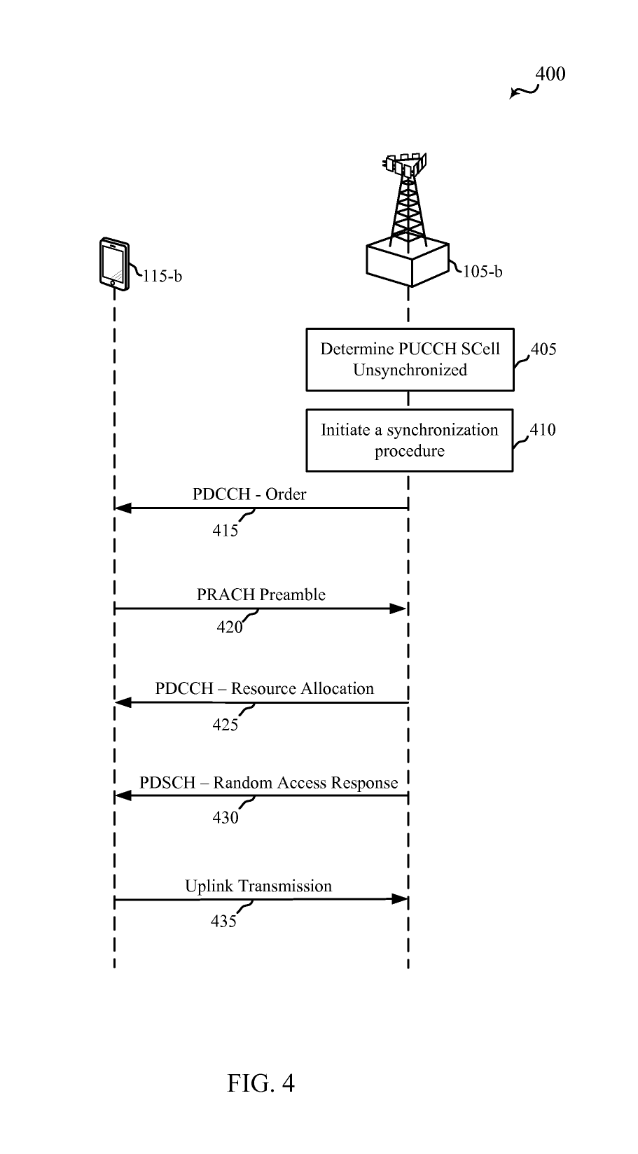

FIG. 4 shows a diagram 400 illustrating a non-contention based random access procedure according to various embodiments. The diagram includes an eNB 105-b and a UE 115-b, which may be examples of the eNBs 105 and UEs 115 described with reference to other figures described herein. The eNB 105-b may determine 405 that a PUCCH SCell is unsynchronized and it may initiate 410 a synchronization procedure. Initiating the random access procedure may include transmitting 415 a PDCCH order to the UE 115-b to perform a random access procedure. The PDCCH order may be transmitted on the PUCCH SCell or another cell, such as a PCell. The UE 115-b may receive the PDCCH order and, in response, transmit 420 a random access preamble on PRACH. The eNB 105-b may receive the PRACH preamble, and transmit 425 a resource allocation on PDCCH and transmit 430 a random access response on PDSCH. The random access response may include a timing advance instruction for the PUCCH SCell or other SCells associated with the PUCCH SCell. The UE 115-b may then regain uplink synchronization with the PUCCH SCell, and it may send 435 uplink transmissions according to the timing advance instruction.

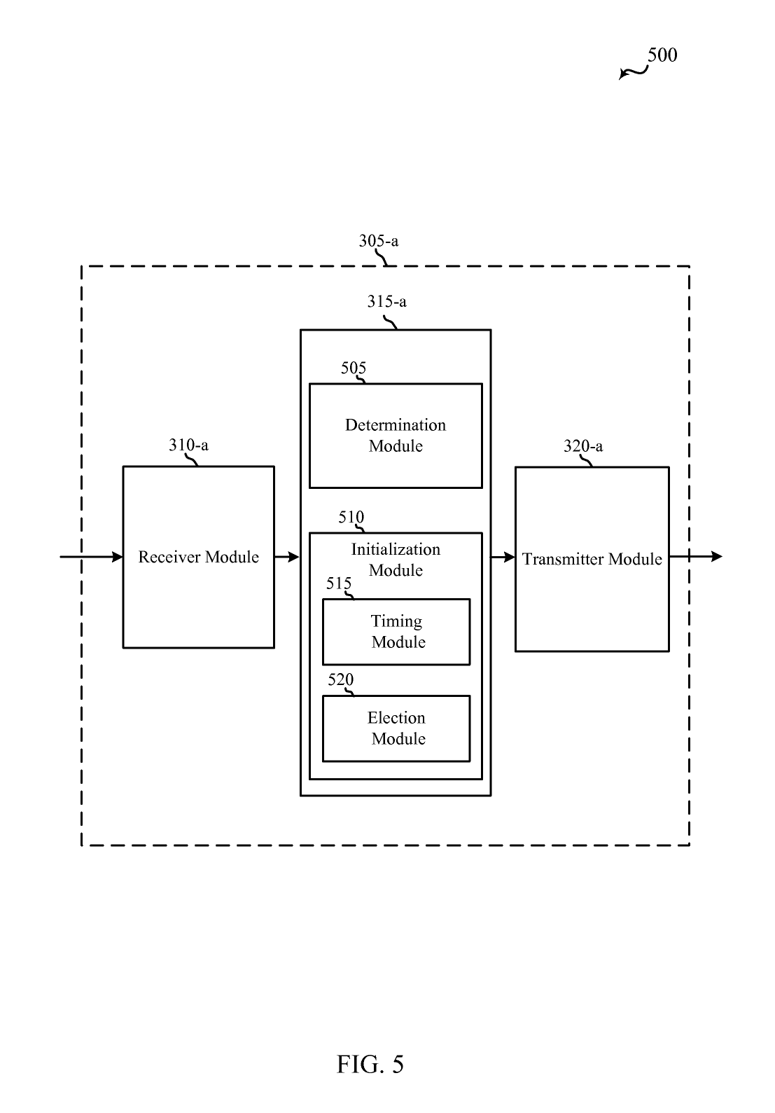

Next, FIG. 5 depicts a block diagram 500 of a device(s) 305-a configured to determine unsynchronization or initiate a synchronization procedure in accordance with various embodiments. The device 305-a may be an example of the device 305 of FIG. 3, and it may be configured to perform the same or similar functions. The device 305-a may include a receiver module 310-a, a controller module 315-a, and a transmitter module 320-a, which may each be in communication with one another, and which may be examples of the corresponding modules of FIG. 3. In some embodiments, one or more aspects of the device 305-a is a processor.

The controller module 315-a may include a determination module 505 and an initialization module 510. The determination module 505 may be configured to determine that a PUCCH SCell (e.g., a PUCCH-SCC) is unsynchronized. The initialization module 510 may be configured to initiate a synchronization procedure.

In some embodiments, the initialization module 510 includes a timing module 515 and an election module 520. The timing module 515 may be configured to determine that a channel or signal of a PUCCH-SCC is undetected for a threshold period of time, which may include a number of consecutive instances. The election module 520 may be configured to elect, based on a determination that a channel or signal is undetected, to cease downlink or uplink scheduling for an SCC associated with the PUCCH-SCC. In various embodiments, the election module is configured to cease scheduling on the PUCCH-SCC, on an SCC different from the PUCCH-SCC, or both.

In some embodiments, the transmitter module 320-a is configured to transmit, based on a determination that a channel or signal is undetected, a PDCCH order, via the PUCCH-SCC, for a UE 115 to perform a random access procedure. In such cases, the receiver module 310-a may be configured to receive a PRACH preamble in response, and the device 305 may be configured to determine and transmit timing advance instructions and discussed herein.

In other embodiments, the receiver module 310-a is configured to receive a PDCCH order, via the PUCCH-SCC or another cell, such as a PCell, to perform a random access procedure. The device 305-a may thus be configured to communicate according to timing advance instructions as discussed herein.

The components of the device 305 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

Referring again to FIG. 2, in some embodiments of the system 200, a PUCCH SCell (e.g., PUCCH-SCC) may be restricted to a TAG that includes the PCell. Thus the system 200 may be configured such that a PCC 225-a and a PUCCH-SCC 225-b are CCs of a common TAG. The PCC 225-a and PUCCH-SCC 225-b may be configured for carrier aggregation. In some embodiments, one of the CCs 225-a and 225-b is configured as a TDD carrier and the other is configured as an FDD carrier.

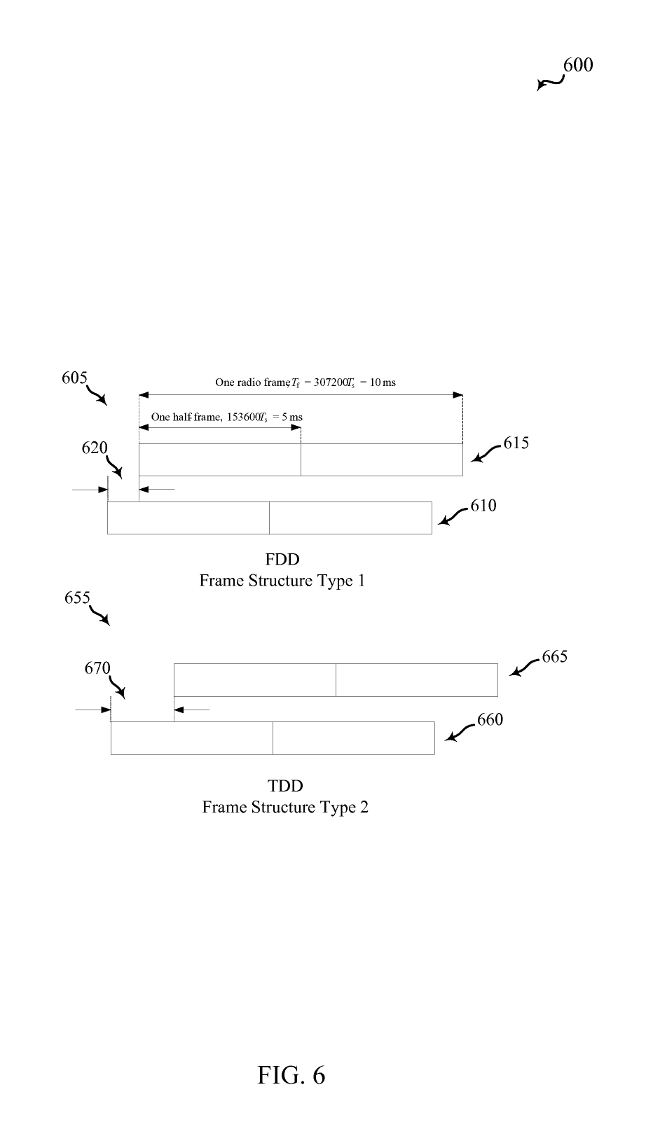

As shown in FIG. 6, and as mentioned above, an UL/DL overlap configuration 600 of an FDD carrier 605 may use paired spectrum resources and may be configured with frame structure type 1, while a TDD carrier 655 may use unpaired spectrum resource and may be configured with frame structure type 2. Time intervals may be expressed in multiples of a basic time unit Tₛ=1/30720000. Each frame structure may have a radio frame length T_{f}=307200·Tₛ=10 ms and may include two half-frames or slots of length 153600·Tₛ=5 ms each.

An FDD UL subframe 610 transmission can overlap a pervious DL subframe 615 transmission without incident because a UE 115 can transmit and receive full duplex FDD simultaneously; and a UE 115 can prioritize transmissions and receptions for half duplex FDD. In an FDD configuration, the UL 610 and DL 615 transmissions may be staggered 620 by a timing advance (e.g., timing adjustment) as indicated to a UE 115 in a random access procedure.

For a TDD configuration, however, an UL subframe 660 transmission and a DL subframe 665 transmission may be staggered 670 by a timing advance and an additional offset. This additional offset may allow an eNB 105 to switch from a receiving to a transmitting mode. For some legacy TDD carriers (e.g., LTE Release 10), a fixed offset may be 20 μs.

Thus, the system 200, when configured for FDD/TDD carrier aggregation, by include a TDD carrier configured without a fixed offset. Alternatively, the system 200 may be configured such the an FDD carrier and a TDD carrier are configured with a common fixed offset. In either case, the staggering 620 of the FDD carrier 605 and the staggering 670 of the TDD carrier 655 may be equal.

In some embodiments, a UE 115 is configured to perform a random access procedure on a PUCCH SCell of an sTAG without a PDCCH order. The UE 115-a, for example, may thus initiate a contention-based random access procedure. In some cases, the UE 115-a may determine that a PUCCH-SCC is unsynchronized and it may initiate a synchronization procedure, including transmitting a random access preamble on PRACH of the PUCCH-SCC. This transmission may be in the absence of receiving an order on PDCCH of the PUCCH-SCC. For example, the UE 115-a may transmit a random access preamble before receiving an order. The UE 115-a may determine that a PUCCH-SCC is unsynchronized by determining that a timing adjustment (TA) timer (e.g., a timeAlignmentTimer discussed above) for a sTAG has expired. Additionally or alternatively, the UE 115-a may undertake additional actions to initiate synchronization. For example, the UE 115-a may flush a HARQ buffer for one or more CCs; it may signal a release of PUCCH or an SRS for a CC; it may purge a configured DL assignment or UL grant; or it may treat all timing adjustment (TA) timers as expired. Likewise, an eNB 105-a in such cases may initiate a synchronization procedure by receiving a random access preamble on the PRACH of the PUCCH-SCC in the absence of transmitting a PDCCH order. In some cases, the eNB 105-a initiates synchronization procedures because it receives a random access preamble before transmitting an order.

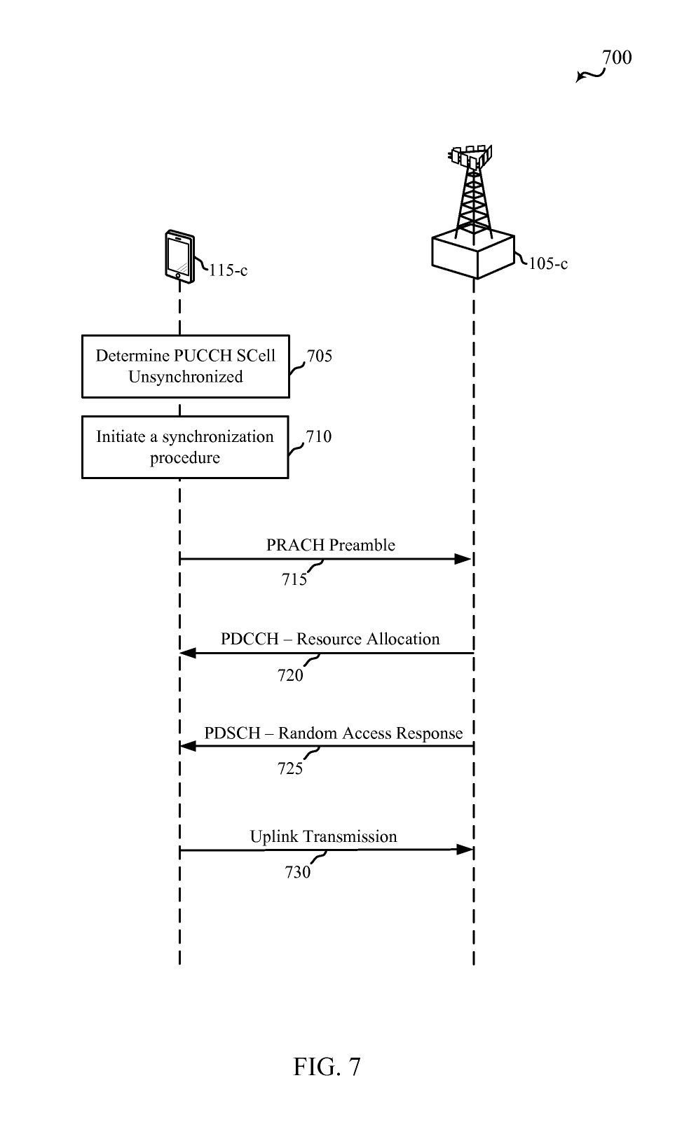

FIG. 7 shows a diagram 700 illustrating a contention-based random access procedure according to various embodiments. The diagram includes an eNB 105-c and a UE 115-c, which may be examples of the eNBs 105 and UEs 115 described with reference to other figures described herein. The UE 115-c may determine 705 that a PUCCH SCell is unsynchronized and it may initiate 710 a synchronization procedure. Initiating the random access procedure may include transmitting 715 a random access preamble on PRACH of the PUCCH SCell. The eNB 105-c may receive the random access preamble, and transmit 720 a resource allocation on PDCCH and transmit 725 a random access response on PDSCH. The random access response may include a timing advance instruction for the PUCCH SCell or other SCells associated with the PUCCH SCell. The UE 115-c may then regain uplink synchronization with the PUCCH SCell, and it may send 730 uplink transmissions according to the timing advance instruction.

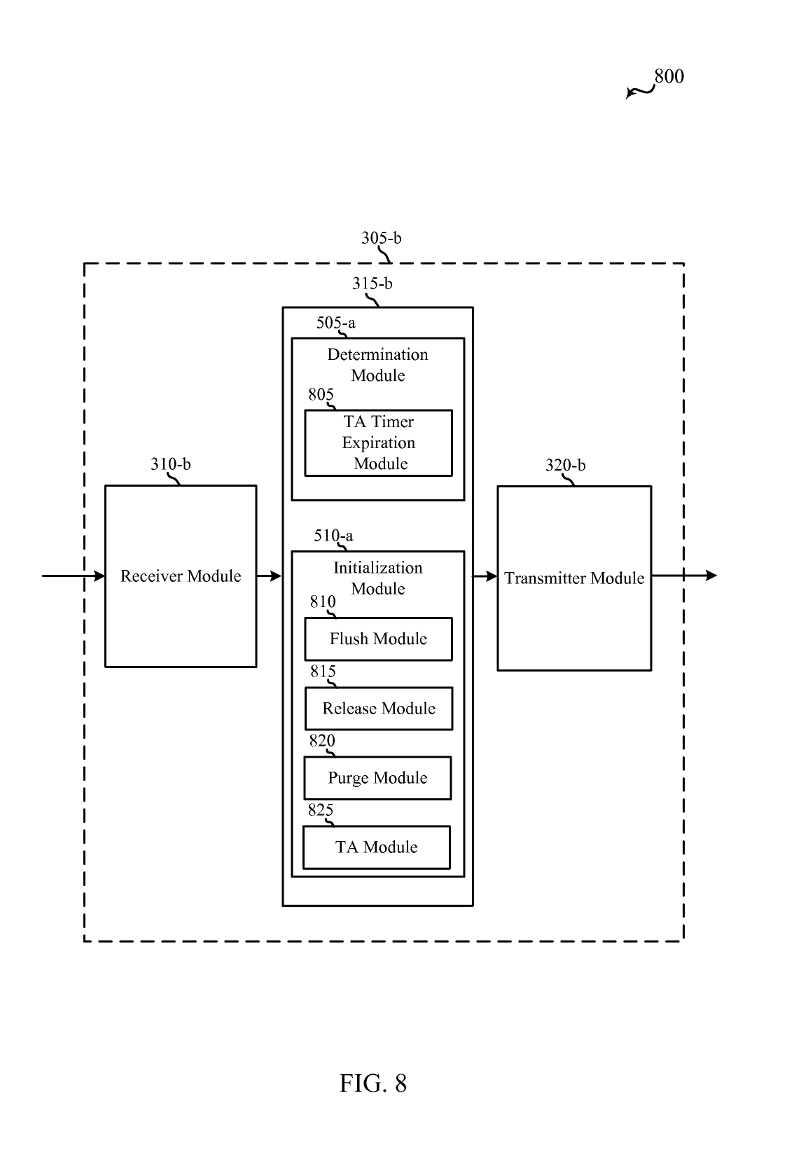

Next, FIG. 8 depicts a block diagram 800 of a device(s) 305-b configured to determine unsynchronization or initiate a synchronization procedure in accordance with various embodiments. The device 305-b may be an example of the devices 305 of FIG. 3 or FIG. 5, and it may be configured to perform the same or similar functions. The device 305-b may include a receiver module 310-b, a controller module 315-b, and a transmitter module 320-b, which may each be in communication with one another, and which may be examples of the corresponding modules of FIG. 3 or 5. In some embodiments, one or more aspects of the device 305-b is a processor.

In some embodiments, the transmitter module 320-b is configured to transmit a random access preamble on PRACH of a PUCCH-SCC irrespective of whether the device 305-b receives a PDCCH order to perform random access procedures. In other embodiments, the receiver module 310-b is configured to receive a random access preamble on PRACH of a PUCCH-SCC irrespective of whether the device 305-b transmits a PDCCH order to perform random access procedures.

The controller module 315-b may include a determination module 505-a and an initialization module 510-a. The determination module 505-a may further include a timing advance (TA) timer expiration module 805, which may be configured to determine that a TA timer for a sTAG has expired. The initialization module 510-a may further include at least one of a flush module 810, a release module 815, a purge module 820, or a TA module 825.

The flush module 810 may be configured to flush a HARQ buffer for one or more CCs. The release module 815 may be configured (e.g., in conjunction with the transmitter module 320-b) to signal for a release of PUCCH or an SRS for one or more CCs. The purge module 820 may be configured to purge configured or scheduled downlink assignments or uplink grants. And the TA module 825 may be configured to identify and cause the device 305-b to treat all TA timers (e.g., timers associated with other sTAGs or pTAGs) as expired.

The components of the device 305-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

Referring again to the system 200 of FIG. 2: in some embodiments, the UE 115-a may transmit, and the eNB 105-a may receive and recognize, signaling or a message indicative of uplink unsynchronization. For example, the UE 115-a may determine that a PUCCH-SCC is unsynchronized, and it may initiate a synchronization procedure by transmitting an unsynchronization alert message to an eNB 105-a. As mentioned above, the various systems described herein may be capable of asynchronous operation; and, in some cases, asynchronous operation may be desirable. Accordingly, the UE 115-a may, in some examples, transmit an unsynchronization alert message only upon the occurrence of a triggering event. Examples of triggering events may include: receiving an uplink grant for an SCC associated with an sTAG of a PUCCH-SCC; receiving a downlink grant for an SCC associated with a PUCCH-SCC; recognizing an SRS or CSI configuration requires transmitting the alert; or the like. An unsynchronization message may be a MAC or RRC signal.

A UE 115 may transmit an unsynchronization alert message on one of several different CCs. In some cases, the UE 115-a may transmit the unsynchronization alert message on a PCell. In other examples, the UE 115-a transmits the unsynchronization message on another SCC of the pTAG. In still other cases, including in the single-serving-base station carrier aggregation case, the UE 115-a may transmit, and the eNB 105-a may receive, the unsynchronization message on a CC of another TAG (e.g., a synchronized TAG), which terminates at the eNB 105-a.

An eNB 105 may receive an unsynchronization message. In response, the eNB 105 may transmit a PDCCH order, for the PUCCH-SCC, for a UE 115 to perform a random access procedure.

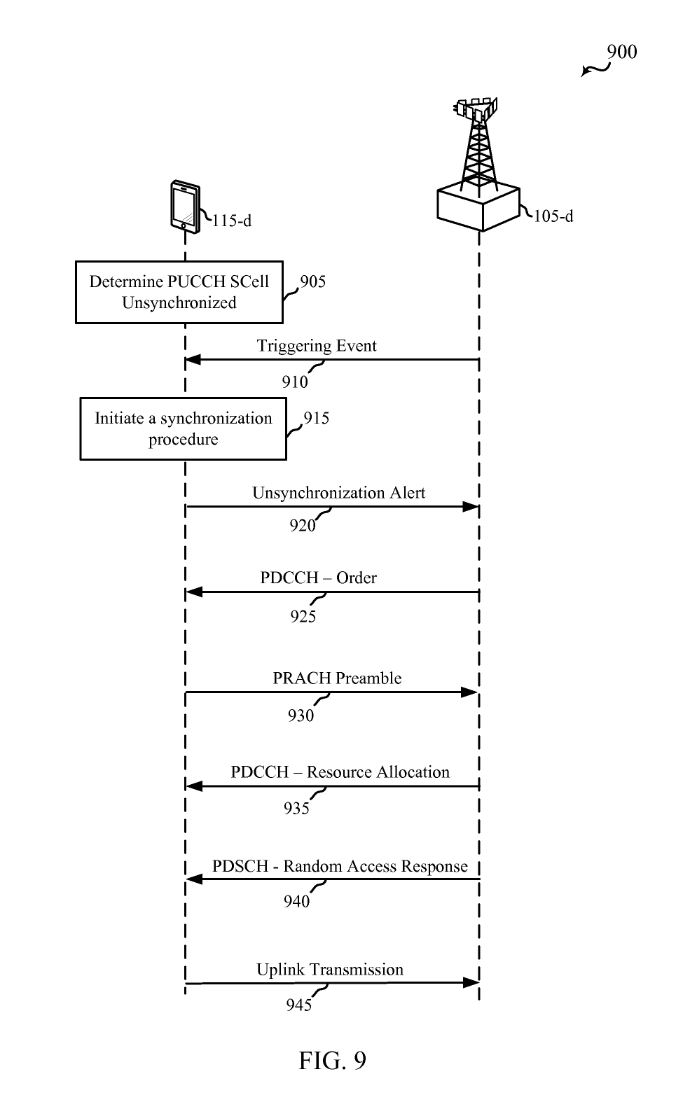

FIG. 9 shows a diagram 900 illustrating a synchronization procedure utilizing an unsynchronization alert message, in accordance with to various embodiments. The eNB 105-d and a UE 115-d may be examples of the eNBs 105 and UEs 115 described with reference to other figures described herein. The UE 115-d may determine 905 that a PUCCH SCell is unsynchronized. Additionally, the UE 115-d may experience 910 a triggering event—e.g., receiving a grant, from the eNB 105-d. The UE 115-d may thus initiate 915 a synchronization procedure, which may include transmitting 920 an unsynchronization alert message. The eNB 105-d may receive the unsynchronization alert message and, in response, transmit 925 a PDCCH order to the UE 115-d to perform a random access procedure. The PDCCH order may be transmitted on a PUCCH SCell or another cell, such as a PCell. The UE 115-d may receive the PDCCH order and transmit 930 a random access preamble on a PRACH. The eNB 105-d may receive the preamble, and transmit 935 a resource allocation on PDCCH and transmit 940 a random access response on PDSCH. The random access response may include a timing advance instruction for the PUCCH SCell or other SCells associated with the PUCCH SCell. The UE 115-d may then regain uplink synchronization with the PUCCH SCell, and it may send 945 uplink transmissions according to the timing advance instruction.

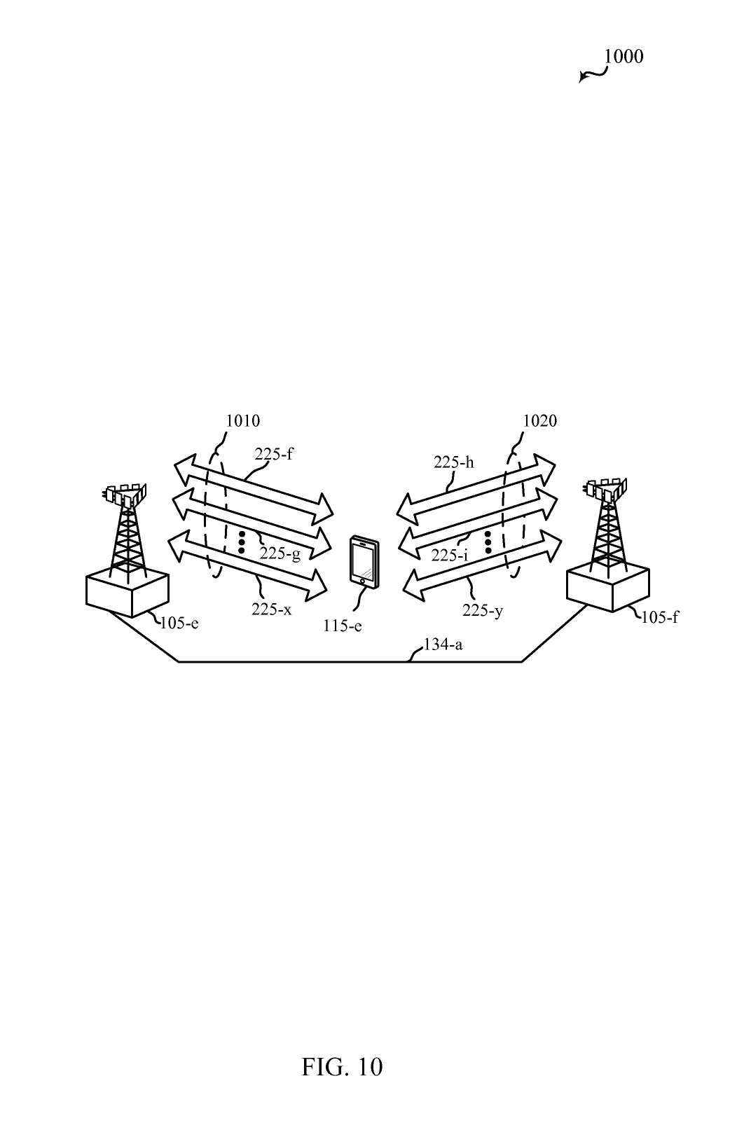

Turning now to FIG. 10, shown is an example of a wireless communications system 1000 with a UE 115-e served by carriers 225 in a dual-connectivity arrangement in accordance with various embodiments. The system 1000 may be an example of various aspects of the system 100 or the system 200 described with reference to FIGS. 1 and 2. In the system 1000, MeNB 105-e may be associated with MCG 1010, which may include multiple carriers (e.g., carriers 225-f, 225-g, 225-x, etc.). In one embodiment, carrier 225-f may be a primary component carrier (e.g., PCell or PCC) and other carriers (e.g., 225-g, 225-x, etc.) may be one or more secondary component carriers (e.g., SCells or SCC). SeNB 105-f may be associated with SCG 1020, which may also include multiple carriers (e.g., carriers 225-h, 225-i, 225-y, etc.). In one embodiment, carrier 225-h may be a PUCCH SCell, while other carriers (e.g., 225-i, 225-y, etc.) of SCG 1020 may be SCells.

As illustrated in FIG. 10, UE 115-e may be configured for dual-connectivity using one or more carriers of MCG 1010 and one or more carriers of SCG 1020. For example, UE 115-e may initially connect to eNB 105-e and may be configured with carrier 225-f as the PCell. PUCCH SCell 225-h may then be configured for UE 115-d using RRC or MAC control element (CE) signaling. Additionally, PUCCH SCell 225-h may be activated and deactivated for UE 115-d using RRC or MAC CE signaling. Signaling to configure, activate, and deactivate PUCCH SCell 225-h may be transmitted using PCell 225-c, for example. This configuration—serving the UE 115-e with SCG 1020—may help alleviate some issues that may arise if the backhaul link 134-a is non-ideal. That is, the dual-connectivity configuration with SCG 1020 may, in some cases, obviate the need to relay uplink control information from the eNB 105-e (with the PCell) to the eNB 105-f (without the PCell) via the backhaul link 134, which may be non-ideal.

In some embodiments, the UE 115-e may determine that the PUCCH SCell 225-h has lost synchronization, and the UE 115-e may initiate a synchronization procedure, including transmitting an unsynchronization alert message. The UE 115-e may transmit the unsynchronization alert message on one of the CCs 225 of the MCG 1010—e.g., because the UE 115-e may assume that all other CCs of the SCG are not functional when the PUCCH SCell has lost synchronization. The MeNB 105-e may communicate (e.g., relay) the unsynchronization alert message to the SeNB 105-f via the backhaul link 134-a. The SeNB 105-f may the receive the alert message and take appropriate action, such as by sending a PDCCH order to the UE 115-e to perform random access procedures. Even if the backhaul link 134-a is non-ideal, the benefit of the UE 115-e determining that the PUCCH SCell is unsynchronized and initiating a synchronization procedure via the MeNB 105-e may be more expedient than relying exclusively on a PDCCH order to regain synchronization.

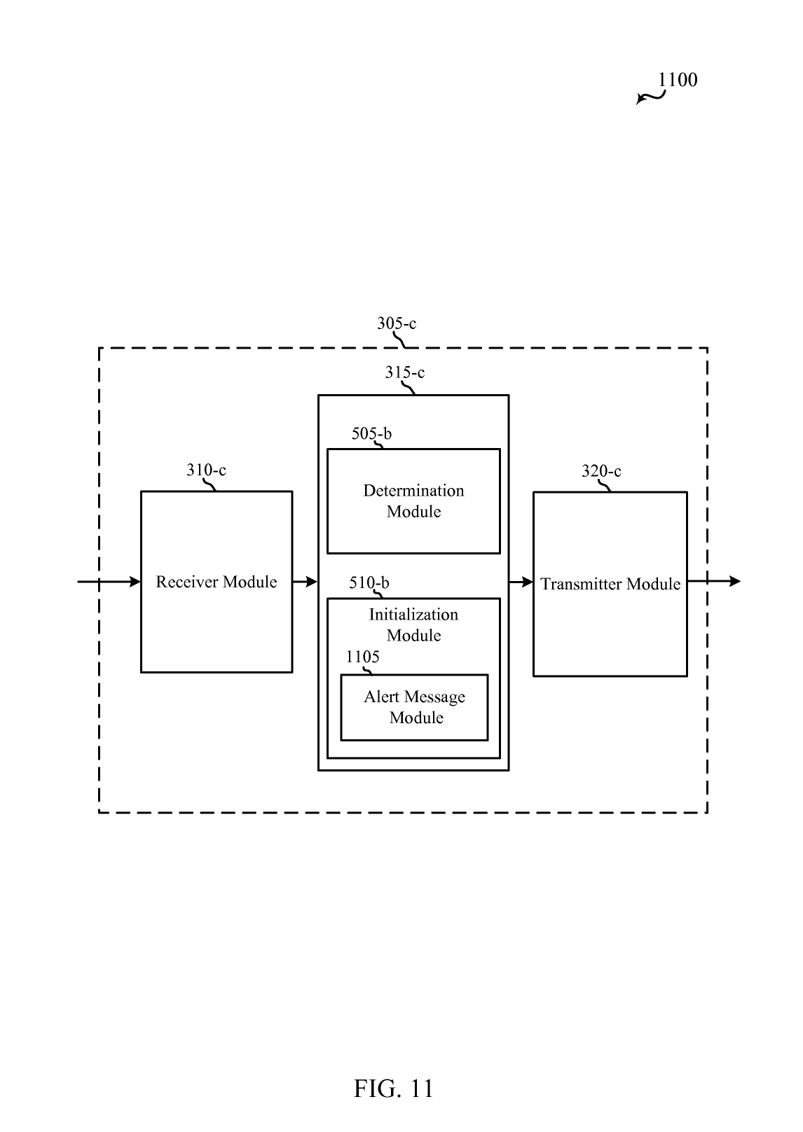

Next, FIG. 11 depicts a block diagram 1100 of a device(s) 305-b configured to determine unsynchronization or initiate a synchronization procedure in accordance with various embodiments. The device 305-c may be an example of the devices 305 of FIG. 3, 5, or 8, and it may be configured to perform the same or similar functions. The device 305-c may include a receiver module 310-c, a controller module 315-c, and a transmitter module 320-c, which may each be in communication with one another, and which may be examples of the corresponding modules of FIG. 3, 5, or 8. In some embodiments, one or more aspects of the device 305-c is a processor.

The controller module 315-c may include a determination module 505-b and an initialization module 510-b, which may also include an alert message module 1105. The alert message module 1105 may be configured to generate an unsynchronization alert message, for example upon the determination module 505-b determining the uplink synchronization of a PUCCH-SCC is lost and upon an occurrence of a triggering event. In some embodiments, the transmitter module 320-c is configured to transmit an unsynchronization alert message generated by the alert message module 1105. In other embodiments, the receiver module 310-c is configured to receive an unsynchronization alert message transmitted from another device. In such cases, the alert message module 1105 may be configured to identify an unsynchronization alert message and to utilize the message to initiate a synchronization procedure.

The components of the device 305-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

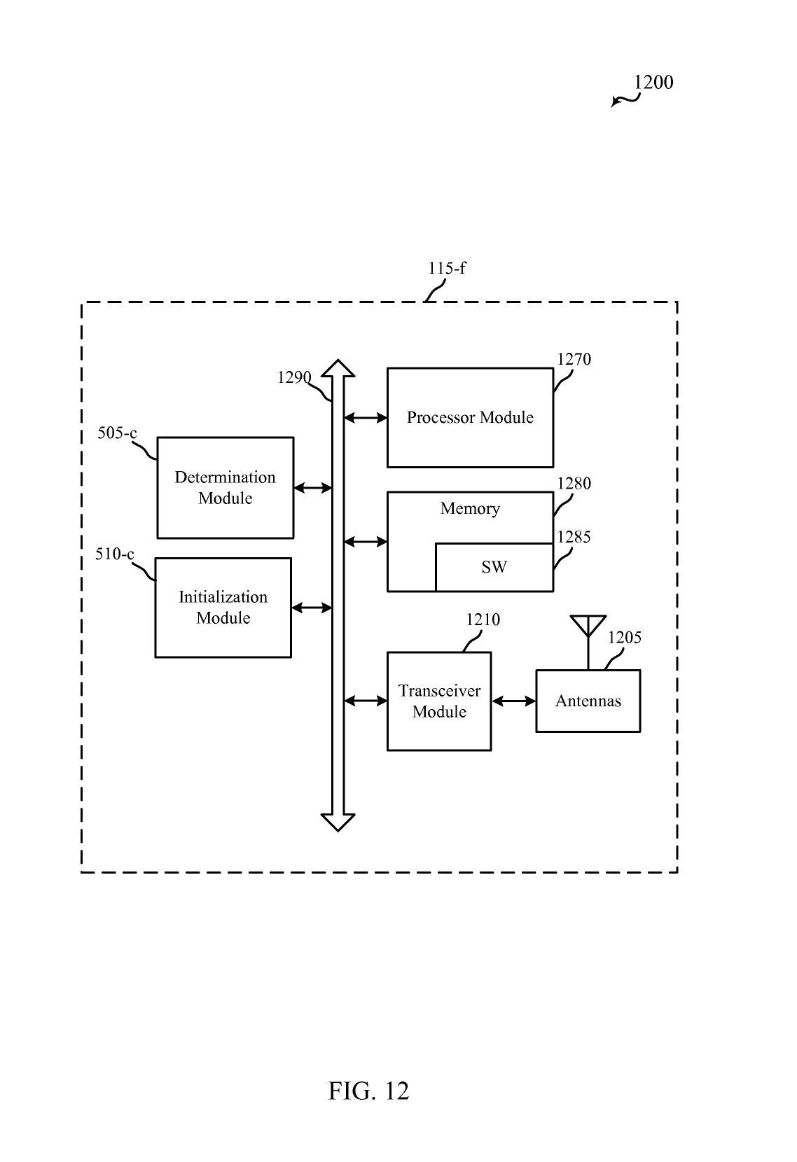

Turning next to FIG. 12, shown is a block diagram 1200 of UE 115-f configured to determine that a PUCCH SCell is unsynchronized or to initiate synchronization procedures. The UE 115-f may have any of various configurations, such as personal computers (e.g., laptop computers, netbook computers, tablet computers, etc.), cellular telephones, PDAs, smartphones, digital video recorders (DVRs), internet appliances, gaming consoles, e-readers, etc. The UE 115-f may have an internal power supply (not shown), such as a small battery, to facilitate mobile operation. In some embodiments, the UE 115-f may be an example of the devices 305 of FIG. 3, 5, 8, or 11.

The UE 115-f may generally include components for bi-directional voice and data communications including components for transmitting communications and components for receiving communications. The UE 115-f may include antenna(s) 1205, a transceiver module 1210, a processor module 1270, and memory 1280 (including software (SW) 1285), which each may communicate, directly or indirectly, with each other (e.g., via one or more buses 1290). The transceiver module 1210 may be configured to communicate bi-directionally, via the antenna(s) 1245 or one or more wired or wireless links, with one or more networks, as described above. For example, the transceiver module 1210 may be configured to communicate bi-directionally with base stations 105 as described herein. The transceiver module 1210 may include a modem configured to modulate the packets and provide the modulated packets to the antenna(s) 1205 for transmission, and to demodulate packets received from the antenna(s) 1205. While the UE 115-f may include a single antenna 1205, the UE 115-f may have multiple antennas 1205 capable of concurrently transmitting or receiving multiple wireless transmissions. The transceiver module 1210 may be capable of concurrently communicating with multiple base stations 105 via multiple CCs in a carrier aggregation or a dual-connectivity configuration.

The memory 1280 may include random access memory (RAM) and read-only memory (ROM). The memory 1280 may store computer-readable, computer-executable software/firmware code 1285 containing instructions that are configured to, when executed, cause the processor module 1270 to perform various functions described herein (e.g., determining that a PUCCH-SCC is unsynchronized or initiating a synchronization procedure, etc.). Alternatively, the software/firmware code 1285 may not be directly executable by the processor module 1270 but may be configured to cause a computer (e.g., when compiled and executed) to perform functions described herein.

The processor module 1270 may include an intelligent hardware device, e.g., a central processing unit (CPU), a microcontroller, an application-specific integrated circuit (ASIC), etc. The UE 115-f may include a speech encoder (not shown) configured to receive audio via a microphone, convert the audio into packets (e.g., 20 ms in length, 30 ms in length, etc.) representative of the received audio, provide the audio packets to the transceiver module 1210, and provide indications of whether a user is speaking.

According to the architecture of FIG. 12, the UE 115-f may further include a determination module 505-c and an initialization module 510-c, which may be substantially the same as the determination modules 505 and the initialization modules 510 of FIG. 5, 8, or 11. In some cases, the determination module 505-c is configured to perform the functions of the module 805 described with reference to FIG. 8; and the initialization module 510-c may be configured to perform the functions of modules 515, 520, 810, 815, 820, 825, or 1105 described with reference to FIGS. 5, 8, and 11. By way of example, the determination module 505-c and the initialization module 510-c may be components of the UE 115-f in communication with some or all of the other components of the UE 115-f via the bus 1290. Alternatively, functionality of these modules may be implemented as a component of the transceiver module 1210, as a computer program product, or as one or more controller elements of the processor module 1270.

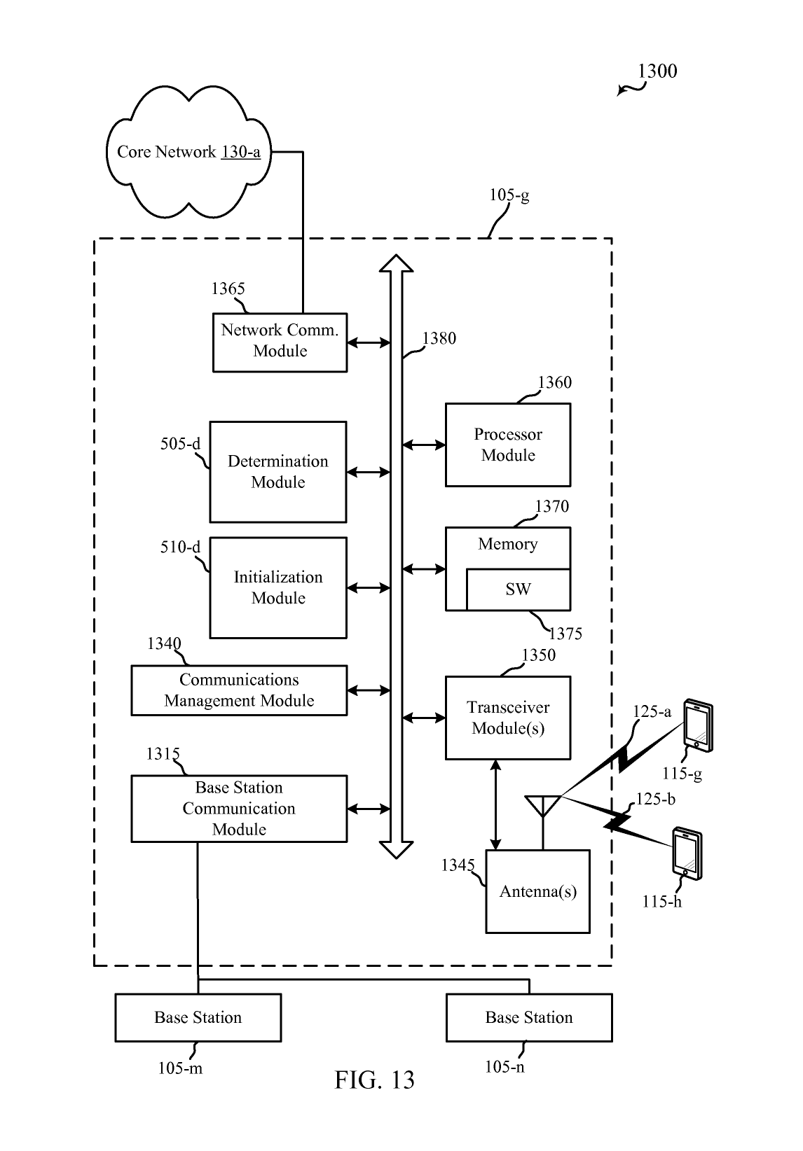

FIG. 13 shows a block diagram of an example system 1300 configured to determine that a PUCCH SCell is unsynchronized or to initiate synchronization procedures. This system 1300 may be an example of aspects of the systems 100, 200, or 1000 depicted in FIGS. 1, 2, and 10. The system 1300 includes an eNB 105-g configured for communication with UEs 115 over wireless communication links 125. The eNB 105-g may be capable of receiving communication links 125 from other base stations (not shown). The eNB 105-g may be, for example, an eNB 105 as illustrated in the preceding figures.

In some cases, the eNB 105-g may have one or more wired backhaul links. The eNB 105-g may be a macro eNB 105 having a wired backhaul link (e.g., 51 interface, etc.) to the core network 130-a. The eNB 105-g may also communicate with other base stations 105, such as base station 105-m and base station 105-n via inter-base station communication (e.g., backhaul) links (e.g., X2 interface, etc.). Each of the base stations 105 may communicate with UEs 115 using the same or different wireless communications technologies. In some cases, eNB 105-g may communicate with other base stations such as 105-m or 105-n utilizing base station communication module 1315. In some embodiments, base station communication module 1315 may provide an X2 interface within an LTE/LTE-A wireless communication network technology to provide communication between some of the base stations 105. In some embodiments, eNB 105-d may communicate with other base stations through core network 130-a. In some cases, the eNB 105-g may communicate with the core network 130-a through network communications module 1365.

The components for the eNB 105-g may be configured to implement aspects discussed above with respect to base stations 105 and or devices 305 of the preceding FIGS. For example, the eNB 105-g may be configured to operate in a carrier aggregation or a dual-connectivity configuration. The eNB 105-g may be configured to determine that a PUCCH-SCC is unsynchronized or it may be configured to initiate synchronization. Additionally or alternatively, the eNB 105-g may be configured to relay an unsynchronization alert message to another eNB 105.

The base station 105-g may include antennas 1345, transceiver modules 1350, a processor module 1360, and memory 1370 (including software (SW) 1375), and which each may be in communication, directly or indirectly, with each other (e.g., over bus system 1380). The transceiver modules 1350 may be configured to communicate bi-directionally, via the antennas 1345, with the UEs 115, which may be UEs of different categories. The transceiver module 1350 (or other components of the eNB 105-g) may also be configured to communicate bi-directionally, via the antennas 1345, with one or more other base stations (not shown). The transceiver module 1350 may include a modem configured to modulate the packets and provide the modulated packets to the antennas 1345 for transmission, and to demodulate packets received from the antennas 1345. The base station 105-g may include multiple transceiver modules 1350, each with one or more associated antennas 1345.

The memory 1370 may include random access memory (RAM) and read-only memory (ROM). The memory 1370 may also store computer-readable, computer-executable software code 1375 containing instructions that are configured to, when executed, cause the processor module 1360 to perform various functions described herein (e.g., determine a synchronization status, initiate synchronization, communicate unsynchronization alerts, etc.). Alternatively, the software 1375 may not be directly executable by the processor module 1360 but be configured to cause the computer, e.g., when compiled and executed, to perform functions described herein.

The processor module 1360 may include an intelligent hardware device, e.g., a central processing unit (CPU), a microcontroller, an application-specific integrated circuit (ASIC), etc. The processor module 1360 may include various special purpose processors such as encoders, queue processing modules, base band processors, radio head controllers, digital signal processors (DSPs), and the like.

According to the architecture of FIG. 13, the eNB 105-g may further include a communications management module 1340. The communications management module 1340 may manage communications with other base stations 105. The communications management module may include a controller or scheduler for controlling communications with UEs 115 in cooperation with other base stations 105. For example, the communications management module 1340 may perform scheduling for transmissions, including cross-carrier scheduling of CCs, to UEs 115 or various interference mitigation techniques such as beamforming or joint transmission. In some embodiments, the eNB 105-g is an MeNB 105 configured to serve the UEs 115 with SeNBs 105. In other embodiments, the eNB 105-g is an SeNB 105.

Additionally or alternatively, the eNB 105-g may include a determination module 505-c, which may be configured substantially the same as the modules 505 described with reference of FIGS. 5, 8, and 11. In some cases, the determination module 505-d is configured to perform the functions of the module 805 described with reference to FIG. 8; and the initialization module 510-d may be configured to perform the functions of modules 515, 520, 810, 815, 820, 825, or 1105 described with reference to FIGS. 5, 8, and 11. Alternatively, functionality of the determination module 505-d or the initialization module 510-d may be implemented as a component of the transceiver module 1350, as a computer program product, as one or more controller elements of the processor module 1360, or as an element of the communications management module 1340.

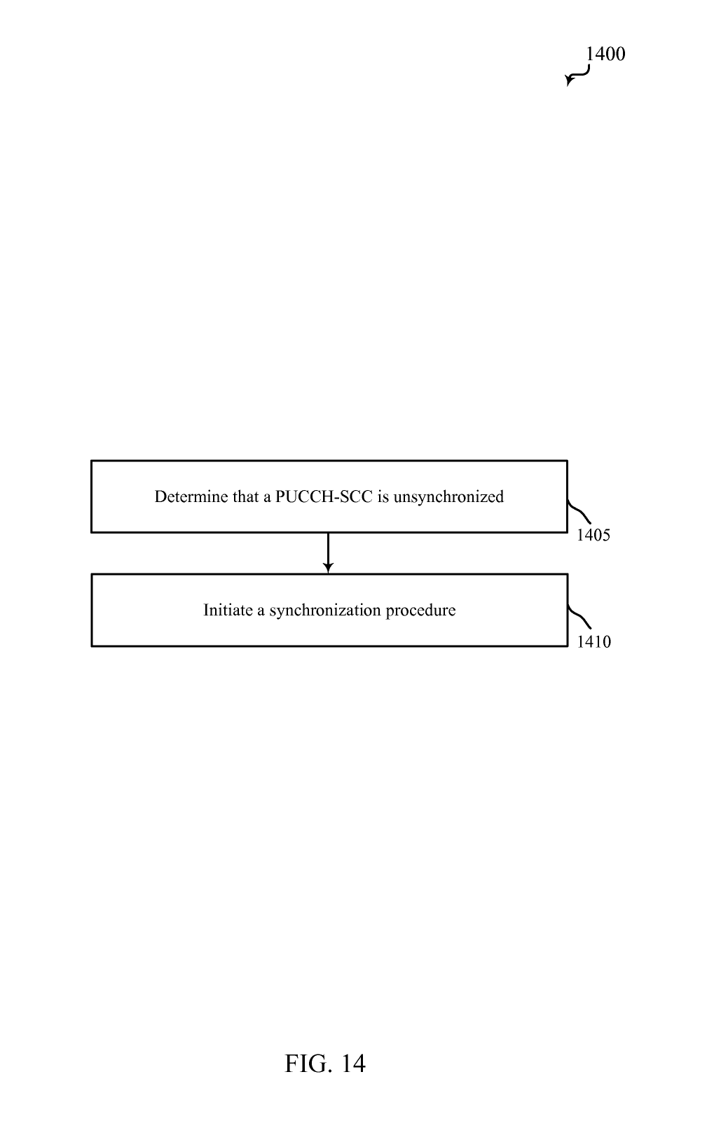

In FIG. 14, a flowchart of a method 1400 for communicating in a wireless communication network, according to various embodiments, is shown. The method 1400 may be implemented by one or more of the UEs 115 or eNBs 105 of the preceding figures. Additionally or alternatively, the operations of the method 1400 may be performed by the receiver modules 310, the controller modules 315, the transmitter modules 320, the determination modules 505, or the initialization modules 510 described with reference to FIGS. 3, 5, 8, and 11.

At block 1405, the method may include determining that a PUCCH-SCC is unsynchronized. At block 1410, the method may include initiating a synchronization procedure. The PUCCH-SCC may, in some cases, share a TAG with a PCC. In some examples, the PUCCH-SCC and the PCC are configured for carrier aggregation. One of the PUCCH-SCC and PCC may be configured as a TDD carrier and the other configured as an FDD carrier. In some cases, the TDD carrier is configured without a fixed offset; but in other examples, the TDD carrier and the FDD carrier are configured with a common fixed offset. Additionally or alternatively, in some cases, the PUCCH-SCC may be a CC of an sTAG and a PCC may be a CC of a pTAG.

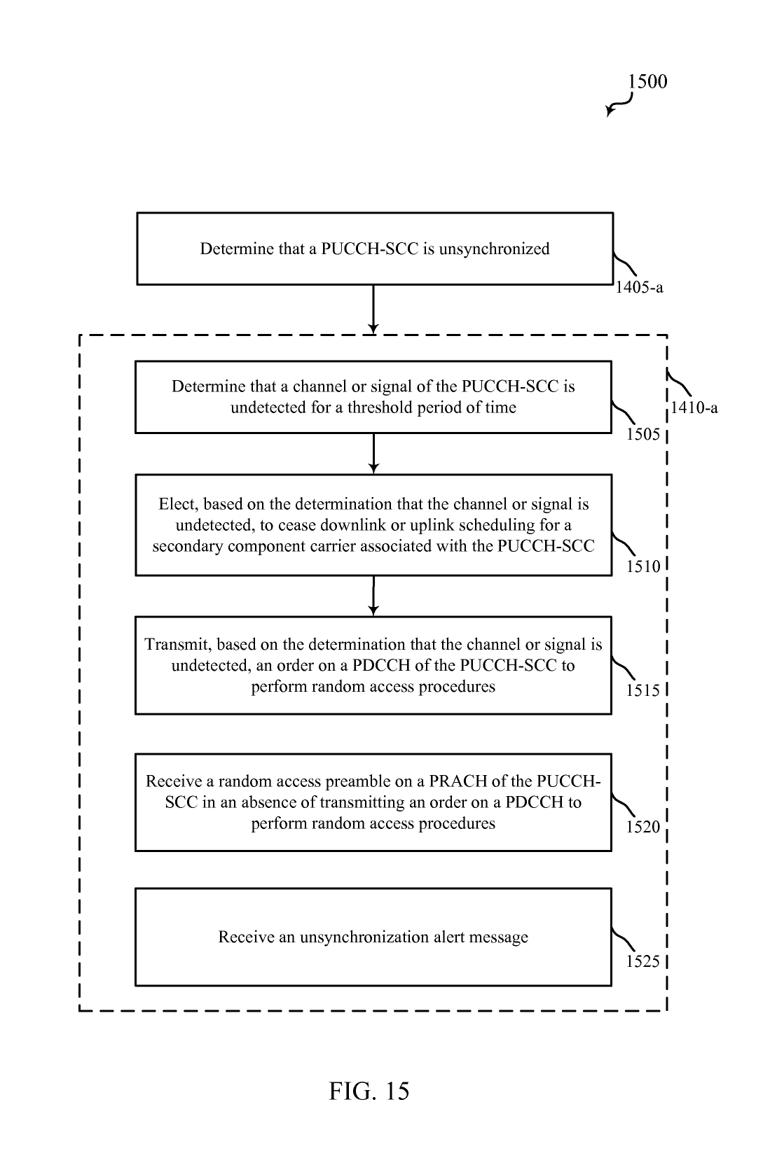

In FIG. 15, flowchart of a method 1500 for communicating in a wireless communication network, according to various embodiments, is shown. The method 1500 may be an example of the method 1400, and it may be implemented by one or more of the eNBs 105 of the preceding figures. Additionally or alternatively, the operations of the method 1500 may be performed by the receiver modules 310, the controller modules 315, the transmitter modules 320, the determination modules 505, or the initialization modules 510 described with reference to FIGS. 3, 5, 8, and 11.

At block 1405-a, the method may include determining that a PUCCH-SCC is unsynchronized. At block 1410-a, the method may include initiating a synchronization procedure. In some embodiments, the method 1500 may include, at block 1505, determining that a channel or signal of the PUCCH-SCC is undetected for a threshold period of time. The channel or signal may be a configured or scheduled transmission. The threshold period of time may, in some cases, include a number of consecutive instances. The operations at block 1505 may be performed by, for example, the timer module 515 described with reference to FIG. 5.

In some embodiments, the method 1500 includes, at block 1510, electing, based on the determination that the channel or signal is undetected, to cease DL or UL scheduling for an SCC associated with the PUCCH-SCC. In some cases, the SCC associated with the PUCCH-SCC is the PUCCH-SCC; in other examples, it is different from the PUCCH-SCC. The operations at block 1510 may be performed by the election module 520 described with reference to FIG. 5.

In some embodiments, the method 1500 includes, at block 1515, transmitting, based on the determination that the channel or signal is undetected, an order on a PDCCH of the PUCCH-SCC to perform random access procedures.

In some embodiments, the method 1500 includes, at block 1520, receiving a random access preamble on a PRACH of the PUCCH-SCC in an absence of transmitting an order on a PDCCH to perform random access procedures. Receiving in the absence of transmitting an order may include receiving before transmitting the order.

In some embodiments, the method 1500 includes, at block 1525, receiving an unsynchronization alert message. The unsynchronization alert message may be a MAC or RRC signal. In some examples, the unsynchronization alert message may be received via a backhaul link from an MCG. In other cases, the unsynchronization alert message may be received on a CC of a synchronized TAG.

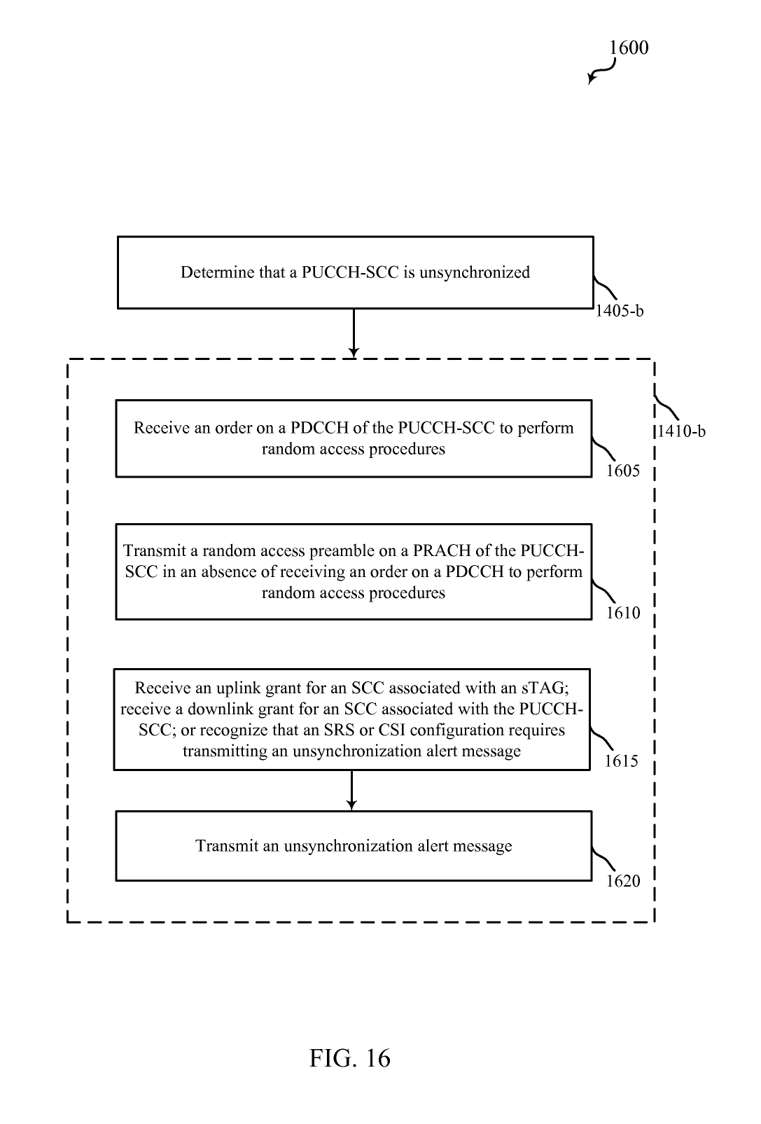

In FIG. 16, flowchart of a method 1600 for communicating in a wireless communication network, according to various embodiments, is shown. The method 1600 may be an example of the method 1400, and it may be implemented by one or more of the UEs 115 of the preceding figures. Additionally or alternatively, the operations of the method 1600 may be performed by the receiver modules 310, the controller modules 315, the transmitter modules 320, the determination modules 505, or the initialization modules 510 described with reference to FIGS. 3, 5, 8, and 11.

At block 1405-b, the method may include determining that a PUCCH-SCC is unsynchronized. At block 1410-b, the method may include initiating a synchronization procedure. In some embodiments, the method 1600 may include, at block 1605, receiving an order on a PDCCH of the PUCCH-SCC to perform random access procedures.

In some embodiments, the method 1600 may include, at block 1610, transmitting a random access preamble on a PRACH of the PUCCH-SCC in an absence of receiving an order on a PDCCH to perform random access procedures. Transmitting in the absence of receiving may include transmitting before receiving. In some embodiments, in addition to transmitting the random access preamble, the method may include at least one of: flushing a HARQ buffer for a CC; signaling for a release of PUCCH or an SRS for a CC; purging a configured DL assignment or an UL grant; or treating all TA timers as expired. In some examples, the method may include communicating with a first base station via a PCC, and communicating with the first base station via the PUCCH-SCC, where the PUCCH-SCC is configured for carrier aggregation, as described above with reference to FIG. 2.

In some embodiments, the method 1600 may include, at block 1615, a triggering event, including: receiving an UL grant for an SCC associated with an sTAG; receiving a DL grant for an SCC associated with the PUCCH-SCC; or recognizing that an SRS or CSI configuration requires transmitting an unsynchronization alert message. The method may additionally include, at block 1620, transmitting an unsynchronization alert message. The unsynchronization alert message may be generated by the alert message module 1105 described with reference to FIG. 11. In some embodiments, the unsynchronization alert message is transmitted on CC of an MCG. In other examples, the unsynchronization alert message is transmitted on a CC of a synchronized TAG.

In some examples, the method may involve communicating with a first base station via a PCC, and communicating with a second base station via the PUCCH-SCC. The first and second base stations may, for example, be connected via a non-ideal backhaul, and the PUCCH-SCC may be configured for dual-connectivity, as described with reference to FIG. 10.

The detailed description set forth above in connection with the appended drawings describes example embodiments and does not represent the only embodiments that may be implemented or that are within the scope of the claims. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” such as when used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of communicating in a wireless communication network configured to support multiple component carriers, the method comprising:
determining that a physical uplink control channel equipped secondary component carrier (PUCCH-SCC) is unsynchronized; and
initiating a synchronization procedure.

2. The method of claim 1, wherein:
the PUCCH-SCC comprises a component carrier of a secondary timing adjustment group (sTAG); and
initiating the synchronization procedure comprises transmitting an unsynchronization alert message.

3. The method of claim 2, further comprising:
communicating with a first base station via a primary component carrier (PCC); and
communicating with a second base station via the PUCCH-SCC, wherein the first and second base stations are connected via a non-ideal backhaul, and wherein the PUCCH-SCC is configured for dual-connectivity.

4. The method of claim 2, wherein the transmitting is conditioned on a triggering event.

5. The method of claim 2, wherein the unsynchronization alert message comprises one of a medium access control signal or a radio resource control signal.

6. The method of claim 2, wherein the transmitting comprises transmitting on a component carrier of a master cell group.

7. The method of claim 1, wherein:
the PUCCH-SCC comprises a component carrier of a secondary timing adjustment group (sTAG); and
initiating the synchronization procedure comprises receiving an unsynchronization alert message.

8. The method of claim 7, wherein the unsynchronization alert message comprises one of a medium access control signal or a radio resource control signal.

9. The method of claim 7, wherein receiving comprises receiving the unsynchronization alert message from a base station of a master cell group via a backhaul link.

10. The method of claim 1, wherein initiating the synchronization procedure comprises:
determining that a channel or signal of the PUCCH-SCC is undetected for a threshold period of time;
electing, based on the determination that the channel or signal is undetected, to cease downlink or uplink scheduling for a secondary component carrier associated with the PUCCH-SCC; and
transmitting, based on the determination that the channel or signal is undetected, an order on a physical downlink control channel of the PUCCH-SCC to perform a random access procedure.

11. The method of claim 1, wherein the PUCCH-SCC and a primary component carrier (PCC) comprise component carriers of a common timing adjustment group.

12. The method of claim 1, wherein the PUCCH-SCC comprises a component carrier of a secondary timing adjustment group (sTAG) and a primary component carrier (PCC) comprises a component carrier of a primary timing adjustment group (pTAG).

13. The method of claim 1, wherein initiating the synchronization procedure comprises:
transmitting a random access preamble on a physical random access channel of the PUCCH-SCC in an absence of receiving an order on a physical downlink control channel to perform random access procedures; and
wherein the PUCCH-SCC is configured for carrier aggregation, and the PUCCH-SCC comprises a component carrier of a secondary timing adjustment group (sTAG).

14. The method of claim 13, wherein:
determining the PUCCH-SCC is unsynchronized comprises determining a timing adjustment (TA) timer for the sTAG expired; and
initiating the synchronization procedure further comprises at least one of:
flushing a hybrid automatic repeat request buffer for a component carrier;
signaling for a release of PUCCH or a sounding reference signal for a component carrier;
purging a configured downlink assignment or an uplink grant; or
treating all TA timers as expired.

15. The method of claim 13, further comprising:
communicating with a first base station via a primary component carrier (PCC); and
communicating with the first base station via the PUCCH-SCC, wherein the PUCCH-SCC is configured for carrier aggregation.

16. The method of claim 1, wherein:
the PUCCH-SCC is configured for carrier aggregation;
the PUCCH-SCC comprises a component carrier of a secondary timing adjustment group; and
initiating the synchronization procedure comprises receiving a random access preamble on a physical random access channel of the PUCCH-SCC in an absence of transmitting an order on a physical downlink control channel to perform random access procedures.

17. A system for communicating in a wireless communication network configured to support multiple component carriers, the system comprising:
means for determining that a physical uplink control channel equipped secondary component carrier (PUCCH-SCC) is unsynchronized; and
means for initiating a synchronization procedure.

18. The system of claim 17, wherein:
the PUCCH-SCC comprises a component carrier of a secondary timing adjustment group (sTAG); and
the means for initiating the synchronization procedure comprises means for transmitting an unsynchronization alert message.

19. The system of claim 18, further comprising:
means for communicating with a first base station via a primary component carrier (PCC); and
means for communicating with a second base station via the PUCCH-SCC, wherein the first and second base stations are connected via a non-ideal backhaul, and wherein the PUCCH-SCC is configured for dual-connectivity.

20. The system of claim 17, wherein initiating the synchronization procedure comprises:
means for transmitting a random access preamble on a physical random access channel of the PUCCH-SCC in an absence of receiving an order on a physical downlink control channel to perform random access procedures; and
wherein the PUCCH-SCC is configured for carrier aggregation, and the PUCCH-SCC comprises a component carrier of a secondary timing adjustment group (sTAG).

21. An apparatus for communicating in a wireless communication network configured to support multiple component carriers, the apparatus comprising:
a processor;
memory in electronic communication with the processor; and
instructions stored on the memory, the instructions are executable by the processor to:
determine that a physical uplink control channel equipped secondary component carrier (PUCCH-SCC) is unsynchronized; and
initiate a synchronization procedure.

22. The apparatus of claim 21, wherein:
the PUCCH-SCC comprises a component carrier of a secondary timing adjustment group (sTAG); and
the instructions are executable by the processor to transmit an unsynchronization alert message.

23. The apparatus of claim 22, wherein the instructions are executable by the processor to:
communicate with a first base station via a primary component carrier (PCC); and
communicate with a second base station via the PUCCH-SCC, wherein the first and second base stations are connected via a non-ideal backhaul, and wherein the PUCCH-SCC is configured for dual-connectivity.

24. The apparatus of claim 22, wherein the transmitting is conditioned on a triggering event.

25. The apparatus of claim 21, wherein:
the PUCCH-SCC comprises a component carrier of a secondary timing adjustment group (sTAG); and
the instructions are executable to receive an unsynchronization alert message.

26. The apparatus of claim 21, wherein the PUCCH-SCC and a primary component carrier (PCC) comprise component carriers of a common timing adjustment group.

27. The apparatus of claim 21, wherein the PUCCH-SCC comprises a component carrier of a secondary timing adjustment group (sTAG) and a primary component carrier (PCC) comprises a component carrier of a primary timing adjustment group (pTAG).

28. The apparatus of claim 21, wherein the instructions are executable by the processor to:
transmit a random access preamble on a physical random access channel of the PUCCH-SCC in an absence of receiving an order on a physical downlink control channel to perform random access procedures; and
wherein the PUCCH-SCC is configured for carrier aggregation, and the PUCCH-SCC comprises a component carrier of a secondary timing adjustment group (sTAG).

29. The apparatus of claim 28, wherein the instructions are executable by the processor to:
communicate with a first base station via a primary component carrier (PCC); and
communicate with the first base station via the PUCCH-SCC, wherein the PUCCH-SCC is configured for carrier aggregation.

30. A non-transitory computer-readable medium storing code for communicating in a wireless communication network configured to support multiple component carriers, the code comprising instructions executable to:
determine that a physical uplink control channel equipped secondary component carrier (PUCCH-SCC) is unsynchronized; and
initiate a synchronization procedure.
